(19) United States
(12) Patent Application Publication
(10) Pub. No.: US 2010/0177599 A1
(43) Pub. Date: Jul. 15, 2010

(54) DETERMINING LOCATION AND SURVIVABILITY OF A TRAPPED PERSON UNDER A DISASTER SITUATION BY USE OF A WIRST WEARABLE DEVICE

(76) Inventor: Yang Pan, (US)

Correspondence Address: Yang Pan;Intellectual Power Pte Ltd, No. 14 Robinson Road #06-01,, Far East Finance Building, Singapore, 048545, SG

(21) Appl. No.: 12/351,839

(22) Filed: Jan. 11, 2009

(51) Int. Cl. G04B 47/06; G08B 17/00

(52) U.S. Cl. 368/11; 340/584

(57) ABSTRACT

A wrist wearable computing and communication device for an emergency occasion is disclosed. The device, for example, is useful for a trapped person under a mound of debris created by a fallen building during an earthquake or a terrorist attack. The invention is based upon a conventional wrist electronic watch with an additional sensory unit for sensing survivability of the trapped person and a communication unit for communicating with an external device. The invention is characterized by that an authorized signal delivered by a nearby mobile rescue station will switch on the sensory unit of the wearable device to provide the information with regard to trapped person's status. In one embodiment, a pressure sensor on the backside of the wearable device is used to measure the wrist induced pressure to confirm if the device is worn and a temperature sensor to measure the body temperature of the trapped person after the confirmation. In another embodiment, a motion sensor is used to measure the movement of the wrist after an alerting signal is triggered by the mobile rescue station.

### CROSS-REFERENCE TO RELATED APPLICATIONS

The application relates to the U.S. patent application Ser. No. 12/344519 entitled “Determining location and survivability of a captive person under a disaster situation by use of a mobile device”, submitted by Yang Pan on Dec. 28, 2008.

### BACKGROUND

1. Field of Invention

This invention relates to a mobile computing and communication device, specifically to a wrist wearable device for determining location and survivability of a trapped person under a disaster situation.

2. Description of Prior Art

A person may encounter many different dangerous situations during his or her life. For example, a person may be trapped under a mound of debris created by a fallen building during an earthquake or a terrorist attack. A rescue team is sent to fallen building to search for survivors. It is important for the rescue team to identify the location and the status of the trapped person to save the person's life effectively. Although an electronic watch has become a popular wrist wearable device, the use of the device for the emergency situation has not been fully exploited. The electronic watch with extremely low power consumption is in particularly suitable for a rescue operation which may last a long period of time (e.g. more than a week).

Therefore, it is desirable to have a device and method based upon a popular wrist wearable device such as an electronic watch for locating a trapped person and for determining his or her status under a disaster situation. It allows a rescue team to have more opportunities to save a person's life.

### SUMMARY OF THE INVENTION

The invention is for a wrist wearable computing and communication device. In an exemplary embodiment, an electronic watch based device is used to illustrate the inventive concept, which should not limit the scope of the present invention. The inventive concept can be extended to other wearable devices such as a wrist wearable PC, a wrist wearable phone or a bracelet embedded with a computing and communication device. In one implementation, the electronic watch may further include a communication unit such as a ZigBee transceiver. ZigBee is a short range communication standard conforming to IEEE 802.15.4 and its amendments. ZigBee devices are operated with very low power consumption as known in the art.

The electronic watch may further include a sensory unit for detecting survivability of a trapped person. In one implementation, the sensory unit comprises a pressure sensor and a temperature sensor on the back surface of the watch. The pressure sensor detects an applied pressure when the watch is worn by the person. The temperature sensor then detects body temperature of the person wearing the watch. It is known that the body temperature of a person relates to surviving status of the person. In another implementation, a motion sensor is used to detect the movement of the wrist after receiving a signal from an external device operated by a rescue team.

The external device receives collected signals from the sensory unit through an ad hoc communication network. The status of the trapped person is then analyzed. The location of the trapped person may be determined by a zonal method based upon the ad hoc network. Disposable devices with the ZigBee communication capability may be deposited at selected locations to form existing ZigBee nodes. The location of the trapped person with the wearable device, including the ZigBee transceiver, may be determined based upon its relationship with the existing nodes. The method can be extended to a case of multiple persons and multiple rescue stations in a significant disaster situation.

### BRIEF DESCRIPTION OF THE DRAWINGS

For a more complete understanding of the present invention and its various embodiments, and the advantages thereof, reference is now made to the following description taken in conjunction with the accompanying drawings, in which:

FIG. 1 is a functional block diagram of a wrist wearable device illustrating the present invention.

FIG. 2 is a schematic diagram of one implementation of the present invention by employing an electronic watch. A pressure sensor and a temperature sensor are installed on the back surface of the watch and another temperature sensor is installed on the front surface of the watch.

FIG. 3 shows a schematic diagram that the mobile rescue station sends an authorized signal to the wrist wearable device and triggers the operation of the sensory and communication units.

FIG. 4 shows a flow diagram of the operation that the wrist wearable device is used to collect the status of the trapped person and to communicate with the mobile rescue station.

### DETAILED DESCRIPTION

The present invention will now be described in detail with references to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps have not been described in detail in order not to unnecessarily obscure the present invention.

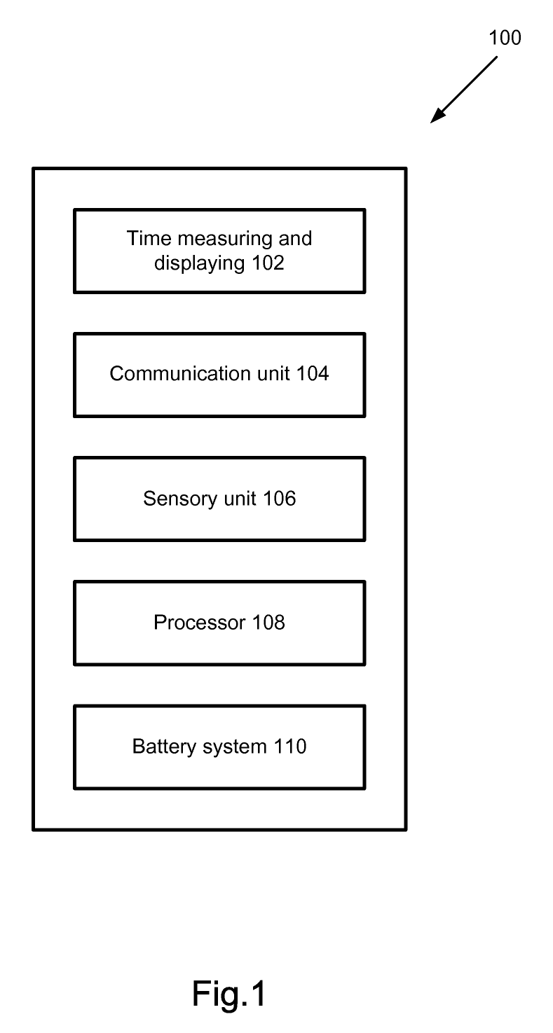

FIG. 1 is a schematic functional block diagram of a wrist wearable device 100 as an illustration of the present invention. The wearable device 100 includes a time measuring and displaying unit 102, which is the functional block of a conventional electronic watch. The device 100 further includes a communication unit 104. In accordance with one implementation, 104 is a short range communication device. It may form an ad hoc communication network with other similar devices. The short range communication device consumes typically very low power than other communication devices such as a mobile phone. The wearable device 100 yet further comprises a sensory unit 106. The main function of the sensory unit 106 is to detect the survivability of the trapped person. The unit 106 may also be used to determine if the wearable device is worn by the person. A processor 108, which pertains to be a low power microprocessor or controller, is employed for controlling overall operation of the wearable device. The wearable device 100 is powered by a battery 110, which may be a rechargeable battery in one implementation. It may be a power supply system comprising a rechargeable battery and a solar cell unit.

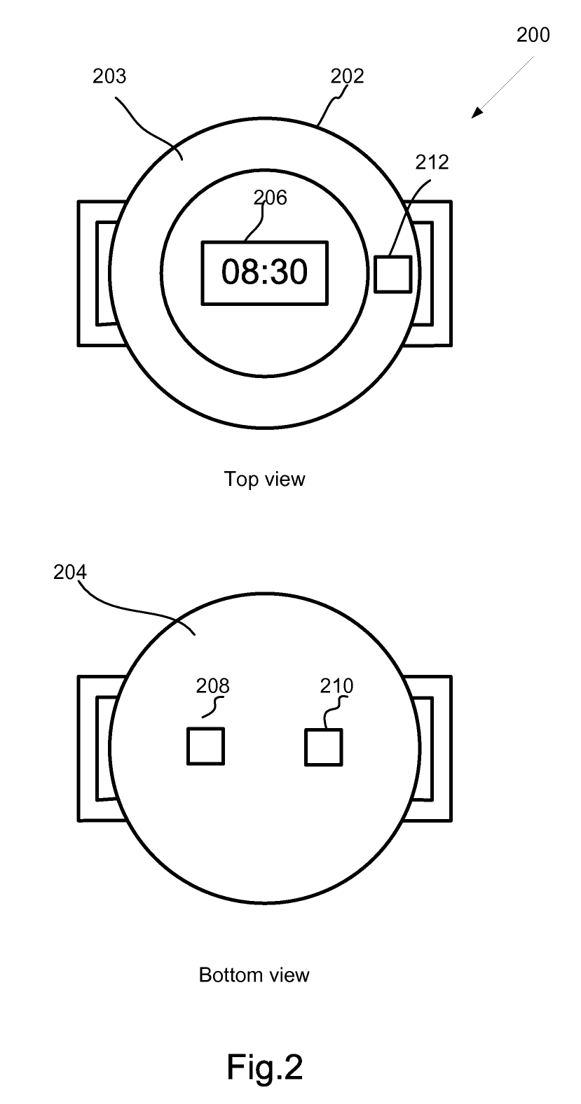

FIG. 2 is a schematic diagram of one implementation of the present invention by employing an electronic watch. The top and bottom views of the exemplary wrist wearable device 200 are shown in the figure. The device 200 includes a device case 202, which comprises a front surface 203 and a back surface 204. An exemplary display window 206 is also shown in the figure for displaying information including the time of the day. The display window may be a LCD (Liquid Crystal Display).

In the exemplary implementation, three sensors are used for the sensory unit. On the back surface of the device 200, a pressure sensor is installed. When the device 200 is worn by a person, a pressure is applied between the wrist and the back surface of the device. The pressure sensor can detect the applied pressure and determine if the watch is worn. A temperature sensor 210 is also installed on the back surface of the device 200. When the device is worn, the back surface is in touch with the person's wrist. The temperature sensor can then measure the body temperature and decide the surviving status of the person wearing the device 200. Another temperature sensor 212 may be installed on the front surface of the device 200. The temperature sensor pair 210/212 may be used to measure the temperature difference between the body and the ambient. The present invention is characterized by that the pressure sensor is used to determine if the device is worn. It is important to note that that the temperature sensor(s) alone can not determine conclusively the status of the person based upon the measuring results.

In another implementation, a motion sensor such as an accelerometer and/or a gyroscope may be installed inside the case of the device 200 (not shown in the figure). A person's interaction with the wearable device may trigger a signal detected by the motion sensor. Thus the person's surviving status can be determined accordingly.

The wearable device 200 may further include a user input unit such as a button for switching on or off the communication unit. The advantage of such a unit is to save power consumption under a normal operation as a time measuring and displaying device. The communication unit will be switched on under an emergency situation under the control of the user. The disadvantage is that the user may not be able to switching on such a function in an emergency case such as the user is injured and unable to operate the device.

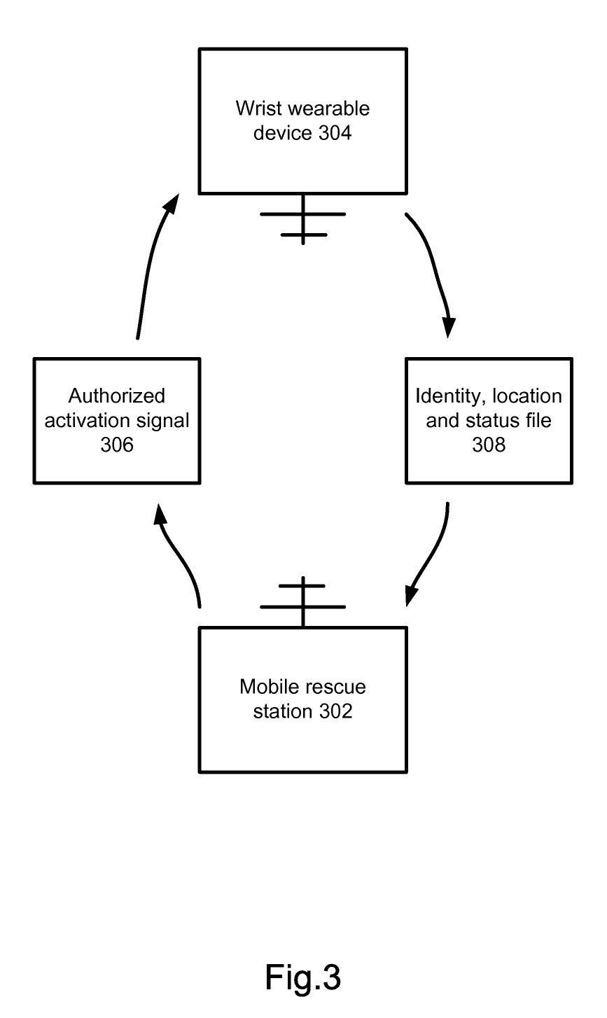

The interaction between the mobile rescue station 302 and the wrist wearable device 304 is further illustrated in FIG. 3. The mobile rescue station 302 sends the authorized signal 306 to the wearable device 304. The mobile rescue station comprises at least a computing and communication device conforming to the same communication standard(s) as the communication unit in the wearable device 304. It may be based upon a laptop computer in an exemplary case. The device 304 sends back a file 308 to the rescue station 302 which may comprise the person's survival status represented by the signals collected from the sensory unit. Although one rescue station and one wearable device are shown in the figure, the inventive concept can be extended to multiple wearable devices and multiple rescue stations. In the case that a zonal method is used to determine the person's location, multiple disposable communication devices including ZigBee transceivers may be deposited in selected locations in the area of interests to form existing nodes of the ad hoc network. Locations of trapped persons associated with the respective ZigBee device may be determined based upon their relationship with the existing nodes.

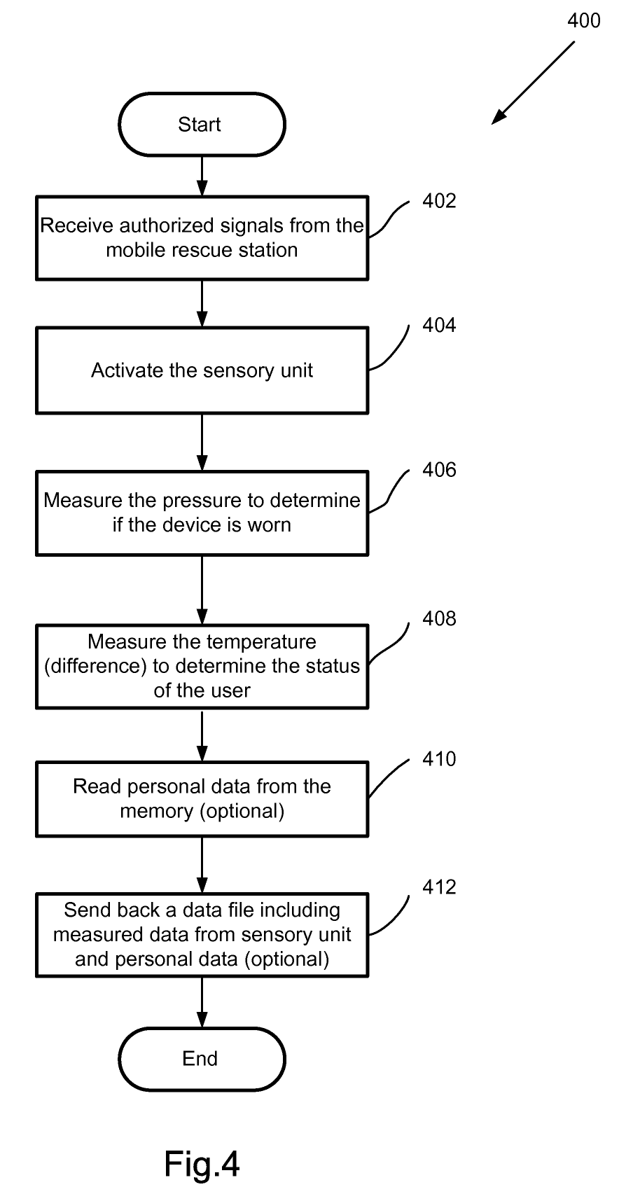

FIG. 4 shows a flow diagram of a process 400 that the mobile rescue station 302 communicating with the wearable device 304. The process begins with a step 402 that the authorized signal is received by the wearable device 304 from the mobile rescue station 302. After receiving the signal, the wearable device 304 activates the sensory unit in step 404. The pressure sensor is used to measure the applied pressure to the back surface of the device 304 in step 406 to determine if the device is worn by the person. The temperature sensor(s) are then employed in step 408 to determine the body temperature of the person. After collecting data from the sensor(s), personal data may be read out from a storage unit of the wearable device 304 in an optional step 410. An electronic watch typically includes a semiconductor memory, which may be part of electronic watch circuitry. Basic personal data may be pre-stored in the memory. A data file including the collected data from the sensory unit and the personal data read out from the storage may be sent to the mobile rescue station 302 in step 412. The location may then be determined by the zonal method described previously.

In an another implementation, an alarming signal such as a flashing light and/or bleeping sound may be delivered by the wearable device 304 after the authorized signal is received. The alarming signals may help the rescue team or personnel to identify the trapped person's location in an accelerated manner.

In yet another implementation, a motion sensor such as for example, an accelerometer and/or a gyroscope may be integrated with the wearable device. The trapped person, noting the alarming signals may move his or he wrist to generate a signal measurable to the motion sensor and, consequently, to the rescue team or personnel.

1. A wrist wearable computing and communication device for a user, comprising:
a sensory unit providing a first means for sensing if said wearable device is worn by the user and a second means for sensing body temperature of the user when said wearable device is worn by the user;
a communication unit providing a means for communicating with an external device;
a processor providing a means for controlling operation of said wearable device; and
a power supply unit providing a means for supplying the power for the wearable device,
wherein said wrist wearable device further comprising a case with at least a front surface and a back surface, wherein the back surface is in contact with the user's wrist when the device is worn.

2. The device as recited in claim 1, wherein said wearable device further comprising a means for measuring and displaying time.

3. The device as recited in claim 1, wherein said wrist wearable device further comprising a user input means for switching on or off the communication unit.

4. The device as recited in claim 1, wherein said sensory unit comprising:
a pressure sensor; and
a temperature sensor,
wherein said sensors are located onto the back surface of said wearable device.

5. The device as recited in claim 4, wherein said sensory unit further comprising another temperature sensor located onto the front surface of the device.

6. The device as recited in claim 1, wherein said communication unit comprising a short range communication device, for providing an ad hoc communication means, conforming to a standard or a combination of standards from the following group:
ZigBee (IEEE 802.15.4 and its amendments);
Bluetooth (IEEE 802.11b and its amendments);
WiFi (IEEE 802.11 and its amendments); and
RFID (Radio-Frequency-ldentification).

7. The device as recited in claim 1, wherein said power supply unit comprising a battery.

8. The device as recited in claim 1, wherein said wriest wearable device further comprising an alarming unit including:
a light-flashing unit; and/or
a sound-bleeping unit.

9. A method of emergency data collection and communication based upon a wearable computing and communication device associated with a trapped person, wherein said device comprising a sensory unit and a communication unit, the method comprising:
detecting by the sensory unit if the wrist device is worn by the person;
detecting by the sensory unit the person's body temperature when said device is worn by the person;
transmitting a data file including data collected from the sensory unit to an external communication device through an ad hoc communication network.

10. The method as recited in claim 9, wherein said wrist wearable device further including a light-flashing unit and/or a sound-bleeping unit, the method further comprising delivering a light-flashing and/or a sound bleeping signal by said wrist wearable device.

11. The method as recited in claim 9, wherein said method further comprising receiving an authorized signal from an external device before triggering said operation of “detecting” by said sensory unit.

12. The method as recited in claim 9, wherein said method further comprising determining the person's location by a zonal method employing the ad hoc network, the zonal method comprising:
depositing a plurality of disposable communication devices in selected locations;
establishing the ad hoc network; and
determining the location of said wrist wearable device based upon its relations to the disposable communication devices,
wherein said disposable communication devices conforming to the same communication standard(s) as the communication unit of said wrist wearable device.

13. The method as recited in claim 9, wherein said communication unit conforming to a standard or a combination of standards from the following group:
ZigBee (IEEE 802.15.4 and its amendments);
Bluetooth (IEEE 802.11b and its amendments);
WiFi (IEEE 802.11 and its amendments); and
RFID (Radio-Frequency-ldentification).

14. The device as recited in claim 9, wherein said sensory unit comprising:
a pressure sensor for measuring pressure induced by the person's wrist when said device is worn; and
a temperature sensor for measuring the body temperature of the person.

15. A method of identifying survivability of a trapped person wearing a wrist computing and communication device, wherein said wrist device comprising a sensory unit for sensing the survivability of the trapped person and a communication unit for communicating through an ad hoc communication network with an external device operated by a rescue personnel, the method comprising:
receiving a signal from the external device;
delivering an alerting signal to the person by an output device of the wrist device;
detecting the person's survivability by the sensory unit;
transmitting the data collected from the sensory unit to the external device.

16. The device as recited in claim 15, wherein said sensory unit comprising a pressure sensor for measuring pressure induced by the person's wrist when said device is worn.

17. The method as recited in claim 15, wherein said sensory unit further comprising:
a temperature sensor providing a means for measuring body temperature of the person; and/or
a motion sensor providing a means for measuring the movement of the person's wrist.

18. The method as recited in claim 15, wherein the wrist wearable device further including an alarming unit including a light-flashing unit and/or a sound bleeping unit, the method further comprising delivering a light-flashing and/or sound bleeping signal after receiving said signal from the external device.

19. The method as recited in claim 15, wherein said motion sensor is an accelerometer and/or gyroscope.

20. The method as recited in claim 15, wherein said communication unit comprising a short range communication device, for providing an ad hoc communication means, conforming to a standard or a combination of standards from the following group:
ZigBee (IEEE 802.15.4 and its amendments);
Bluetooth (IEEE 802.11b and its amendments);
WiFi (IEEE 802.11 and its amendments); and
RFID (Radio-Frequency-ldentification).
